(19) United States
(12) Patent Application Publication
(10) Pub. No.: US 2011/0158213 A1
(43) Pub. Date: Jun. 30, 2011

(54) Short message service transceiving server device, short message service transceiving method and computer program storage product thereof

(75) Inventor: Kuan-Yu Chiang, Taipei City (TW)

(73) Assignee: ITE2 TECHNOLOGY INC., Taipei City (TW)

(21) Appl. No.: 12/926,986

(22) Filed: Dec. 22, 2010

(30) Foreign Application Priority Data
Dec. 24, 2009 (TW) 098144706

(51) Int. Cl. H04W 4/14

(52) U.S. Cl. 370/338; 455/466; 370/328

(57) ABSTRACT

A short message service (SMS) transceiving server device, an SMS transceiving method and a computer program storage product thereof are provided. The SMS transceiving server device comprises a first server unit and a second server unit. The first server device having source information is configured to receive a first user message from a first user device, to assign the source information to the first user message, and to transmit a first SMS with the source information and the first user message to a second user device. When the second user device replies a second SMS with the source information and a second user message in response to the first SMS, the second server unit is configured to receive the second SMS, and to transmit the second user message of the second SMS to the first user device according to the source information.

This application claims priority to Taiwan Patent Application No. 098144706 filed on Dec. 24, 2009, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a short message service (SMS) transceiving server device, an SMS transceiving method and a computer program storage product thereof. More particularly, the present invention relates to an SMS transceiving server device, an SMS transceiving method and a computer program storage product thereof that are capable of managing phone number information of devices that send SMSs and transmitting SMSs between a plurality of user devices according to the phone number information.

2. Descriptions of the Related Art

With rapid development of the wireless communication industry, cell phones and personal digital assistants (PDAs) with mobile communication functionalities have become indispensable to people's daily life. As the cell phones and/or PDAs with mobile communication functionalities all accomplish the mobile communication functionalities by use of phone numbers configured by a telecommunication company, users can use the cell phones and/or PDAs with mobile communication functionalities to communicate with others by use of the phone numbers via the telecommunication network. Further, in additional to audio call and video call functionalities, another commonly used functionality of the cell phones and/or PDAs with mobile communication functionalities is SMS transceiving. Because SMS transceiving has advantages of being cheap in cost and easy to operate, more and more enterprises and manufacturers are now employing SMSs to transmit product information and/or service information to their customers' cell phones or PDAs.

As an enterprise or manufacturer usually has a considerably large number of customers, transmitting SMSs to each customer's cell phone or PDA in sequence according to the customers' phone number information would consume a lot of time and human resources. To solve this problem, a technology of sending SMSs via a computer network platform has been developed by mobile communication service providers. According to this technology, by simply inputting phone number information of the customers into the computer network platform, the enterprise or manufacturer can transmit SMSs to cell phones or PDAs corresponding to the customers' phone number information simultaneously via the computer network platform in one go.

More specifically, the computer network platform mainly consists of a server device that is electrically connected to a telecommunication network and the Internet, and the server device has phone number information configured by a telecommunication company. Thus, the enterprise or manufacturer can connect a device having a network connection capability (e.g., a personal computer (PC) or a PDA) to the server device via the Internet, and transmit product information and/or service information that it desires to send as well as the customers' phone number information to the server device via the Internet so that the server device can transmit SMSs incorporating the product information and/or service information to cell phones or PDAs corresponding to the customers' phone number information via the telecommunication network.

However, the aforesaid technology of sending SMSs via a computer network platform only allows for one-way transmission of SMS; i.e., the enterprise or manufacturer can only transmit SMSs to cell phones or PDAs of its customers via the computer network platform, but cannot receive replying SMSs from the cell phones or PDAs of its customers. More specifically, it is likely that different enterprises or manufacturers may transmit SMSs to their respective customers via the same server device at different time points and/or at the same time points, but phone number information of the SMS source displayed on all the cell phones or PDAs of the customers is the phone number information of the server device configured by the telecommunication company. Consequently, even if a customer replies an SMS to the server device according to the phone number information of the server device configured by the telecommunication company, it is still impossible for the server device to recognize to which enterprise or manufacturer the replying SMS shall be transmitted.

In view of this, efforts still have to be made by mobile communication service providers to satisfy the keen desire of the consumers for a server device that not only allows for a plurality of users to transmit SMSs to a plurality of clients respectively, but can also receive replying SMSs from the clients and recognize to which users the replying SMSs correspond.

### SUMMARY OF THE INVENTION

An objective of the present invention is to provide a short message service (SMS) transceiving server device for transmitting a plurality of user messages between a plurality of user devices. The user devices include a first user device and at least one second user device. The SMS transceiving server device comprises at least one first server unit and a second server unit. The at least one first server unit, which is electrically connected to a telecommunication network and has a source information, is configured to receive a first user message from the first user device, to assign the source information to the first user message, and to transmit a first SMS with the source information and the first user message to the at least one second user device via the telecommunication network. The first SMS has the source information and the first user information. The second server unit, which is electrically connected to the telecommunication network, is configured to receive at least one second SMS with the source information and a second user message from the at least one second user device via the telecommunication network, and to transmit the second user message of the at least one second SMS to the first user device in response to the source information. The at least one second user device replies the at least one second SMS in response to the first SMS.

Another objective of the present invention is to provide an SMS transceiving method adapted for use in an SMS transceiving server device. The SMS transceiving method is adapted for transmitting a plurality of user messages between a plurality of user devices. The user devices include a first user device and at least one second user device. The SMS transceiving method comprises the following steps of: (A) enabling at least one first server unit to provide source information; (B) enabling the at least one first server unit to receive a first user message from the first user device; (C) enabling the at least one first server unit to assign the source information to the first user message; (D) enabling the at least one first server unit to transmit a first SMS with the source information and the first user message to the at least one second user device via a telecommunication network, the first SMS having the source information and the first user information; (E) enabling a second server unit to receive at least one second SMS with the source information and a second user message from the at least one second user device via the telecommunication network; and (F) enabling the second server unit to transmit the second user message of the at least one second SMS to the first user device in response to the source information. The at least one second user device replies the at least one second SMS in response to the first SMS.

To achieve the aforesaid objectives, the present invention further provides a computer program storage product, which comprises a computer readable medium storing a program for an SMS transceiving method. When the program is loaded into an SMS transceiving server device by a computer, the aforesaid SMS transceiving method can be accomplished.

According to the above descriptions, the SMS transceiving server device, the SMS transceiving method and the computer program storage product thereof according to the present invention can transmit a plurality of user messages between a plurality of user devices. Meanwhile, the SMS transceiving server device can assign the source information to a user message in advance, and transmit a message with the source information and the user message to a customer; when the customer replies an SMS with another user message, the replying SMS also has the aforesaid source information. Thus, the SMS transceiving server device, the SMS transceiving method and the computer program storage product thereof according to the present invention will be able to transmit SMSs of a plurality of enterprises or manufacturers to different customers, and receive replying SMSs from the customers and recognize to which enterprises or manufacturer a replying SMS corresponds, thereby avoiding inconveniences in use.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of the present invention;

FIG. 2 is a schematic view of an SMS transceiving server device of the first embodiment;

FIG. 3 is a schematic view of a second embodiment of the present invention;

FIG. 4 is a schematic view of a third embodiment of the present invention;

FIG. 5 is a schematic view of another SMS transceiving server device of the third embodiment;

FIG. 6 is a schematic view of a fourth embodiment of the present invention;

FIG. 7 is a schematic view of an SMS transceiving server device of the fourth embodiment; and

FIG. 8 is a flowchart of an SMS transceiving method of a fifth embodiment of the present invention.

### DESCRIPTION OF THE PREFERRED EMBODIMENT

In the following descriptions, the present invention will be explained with reference to embodiments thereof. The present invention relates to an SMS transceiving server device, an SMS transceiving method and a computer program storage product thereof for transmitting a plurality of user messages between a plurality of user devices. The user devices may be cell phones, personal digital assistants (PDAs), notebook computers or other devices with mobile communication functionalities. It should be appreciated that, descriptions of these embodiments are only for purpose of illustration rather than to limit the present invention. Meanwhile, in the following embodiments and the attached drawings, elements unrelated to the present invention are omitted from depiction; and dimensional relationships among individual elements in the attached drawings are illustrated only for ease of understanding, but not to limit the actual scale.

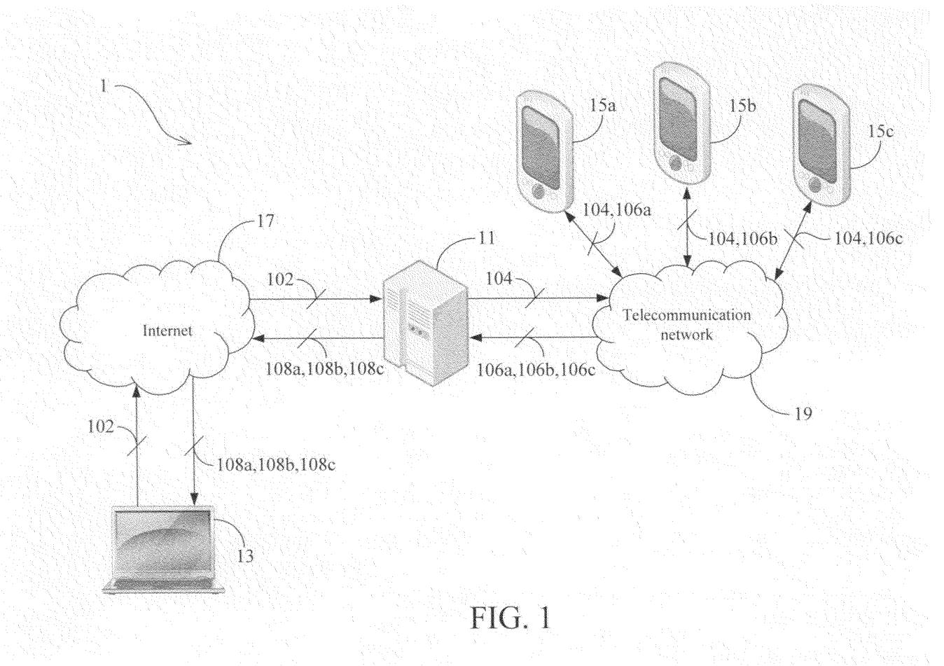

A first embodiment of the present invention is shown in FIG. 1, which is an SMS transceiving system 1. The SMS transceiving system 1 comprises an SMS transceiving server device 11, a first user device 13 and a plurality of second user devices 15a, 15b, 15c. The SMS transceiving server device 11 and the first user device 13 are electrically connected to the Internet 17 via a wireless connection or a wired connection respectively; and the SMS transceiving server device 11 and the second user devices 15a, 15b, 15c are electrically connected to a telecommunication network 19 via a wireless connection or a wired connection respectively.

It shall be particularly noted that, the wireless connection may be one of a Third Generation (3G) mobile network transmission mode, a General Packet Radio Service (GPRS) transmission mode, a Wireless Local Area Network (WLAN) transmission mode and a Worldwide Interoperability for Microwave Access (WiMAX) transmission mode. Additionally, in this embodiment, the first user device 13 is a notebook computer or a personal computer (PC) of an enterprise or manufacturer, and the second user devices 15a, 15b, 15c are cell phones. However, in other embodiments, the first user device 13 may also be a cell phone or PDA, and the second user devices may also be PDAs.

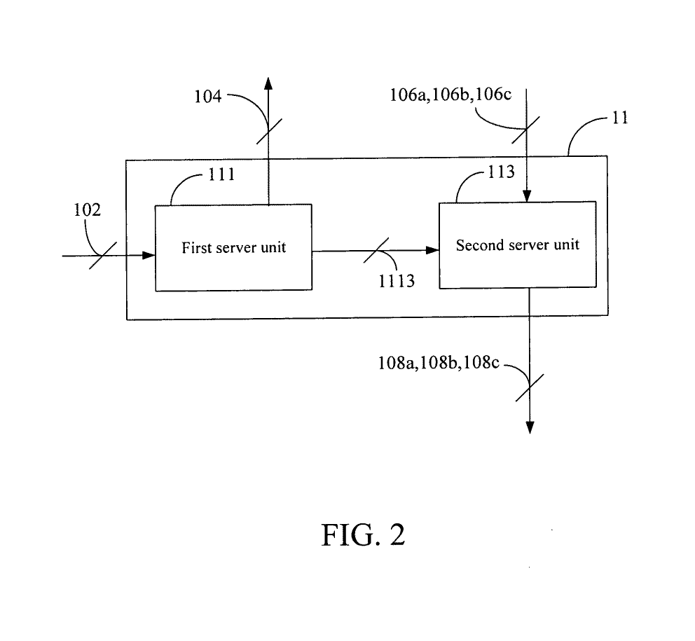

As shown in FIG. 2, the SMS transceiving server device 11 comprises a first server unit 111 and a second server unit 113. The first server unit 111 has source information (e.g., phone number information 1113 configured by a telecommunication company) and is electrically connected with the Internet 17 and the telecommunication network 19. The second server unit 113 is electrically connected with the Internet 17 and the telecommunication network 19. Meanwhile, the first server unit 111 and the second server unit 113 are also electrically connected with each other.

When desiring to have a product questionnaire survey, the aforesaid enterprise or manufacturer may transmit a first user message (e.g., a product questionnaire survey message 102) from the first user device 13 to the SMS transceiving server device 11 via the Internet 17. Then, the first server unit 111 of the SMS transceiving server device 11 receives the product questionnaire survey message 102, assigns the phone number information 1113 to the product questionnaire survey message 102, and then transmits a first SMS 104 with the phone number information 1113 and the product questionnaire survey message 102 to the second user devices 15a, 15b, 15c respectively via the telecommunication network 19.

Further speaking, the first server unit 111 of the SMS transceiving server device 11 can receive the product questionnaire survey message 102 from the first user device 13 through an E-mail or a website via the Internet 17. Subsequently, according to the phone number information 1113 configured by a telecommunication company, the first server unit 111 transmits the first SMS 104 to the second user devices 15a, 15b, 15c via the telecommunication network 19. Thus, the first SMS 104 will have the phone number information 1113 configured by the first server unit 111 of the SMS transceiving server device 11.

After different users have received the first SMS 104 through the second user devices 15a, 15b, 15c respectively, they can decide whether to respond to the product questionnaire survey message 102 transmitted by the enterprise or manufacturer. For example, when the users desire to reply second user messages (e.g., product response messages 108a, 108b, 108c replied in response to the product questionnaire survey message 102), they will transmit second SMSs 106a, 106b, 106c with the phone number information 1113 and the product response messages 108a, 108b, 108c to the SMS transceiving server device 11 through the second user devices 15a, 15b, 15c respectively.

Upon receiving the second SMSs 106a, 106b, 106c from the second user devices 15a, 15b, 15c via the telecommunication network 19, the second server unit 113 of the SMS transceiving server device 11 transmits the product response messages 108a, 108b, 108c of the second SMSs 106a, 106b, 106c to the first user device 13 respectively according to the phone number information 1113 incorporated in the second SMSs 106a, 106b, 106c and the phone number information 1113 of the first server unit 111. Specifically, the second server unit 113 of the SMS transceiving server device 11 transmits the product response messages 108a, 108b, 108c to the first user device 13 through an E-mail or a website via the Internet 17.

It should be particularly noted that, the aforesaid product response messages 108a, 108b, 108c of the second SMSs 106a, 106b, 106c may be temporarily stored by the second server unit 113 of the SMS transceiving server device 11 so that the enterprise or manufacturer can read the product response messages 108a, 108b, 108c through a website via the first user device 13 or receive the product response messages 108a, 108b, 108c transmitted by the second server unit 113 of the SMS transceiving server device 11 through an E-mail by use of an E-mail address.

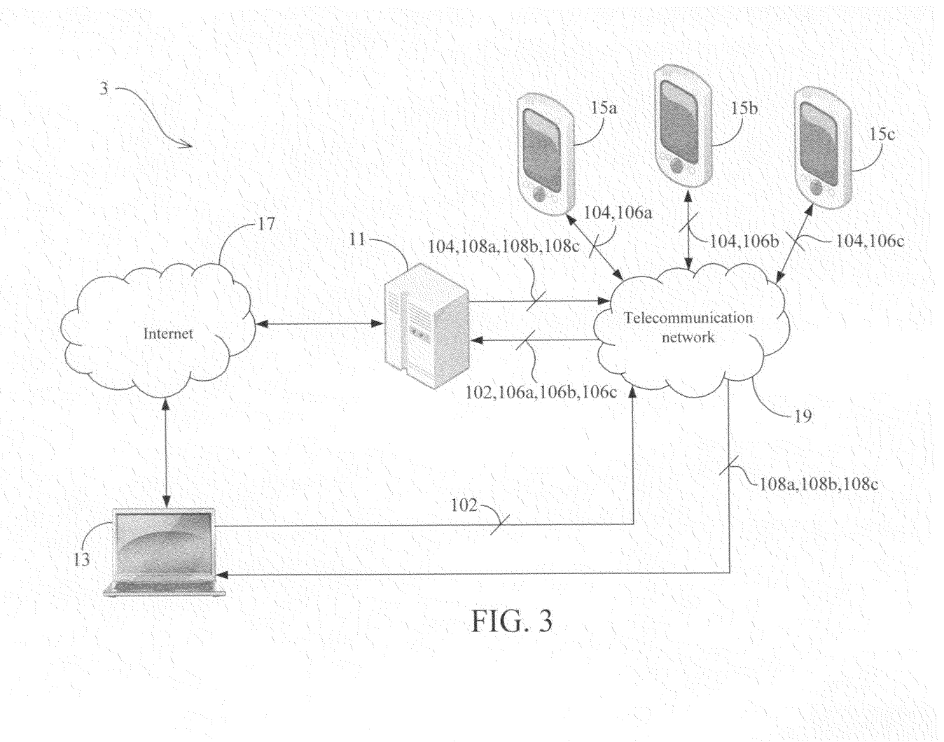

A second embodiment of the present invention is shown in FIG. 3, which is another SMS transceiving system 3. It should be particularly noted that, in the second embodiment, except that the first user device 33 is a PDA and can be electrically connected to the Internet 17 and the telecommunication network 19 via a wireless connection or a wired connection, the other descriptions are mostly the same as those of the first embodiment and, thus, will not be further described herein.

In the second embodiment, the first server unit 111 of the SMS transceiving server device 11 receives the product questionnaire survey message 102 from the first user device 33 through an SMS via the telecommunication network 19. Additionally, the second server unit 113 of the SMS transceiving server device 11 will also transmit the product response messages 108a, 108b, 108c of the second SMSs 106a, 106b, 106c to the first user device 33 through the SMS via the telecommunication network 19.

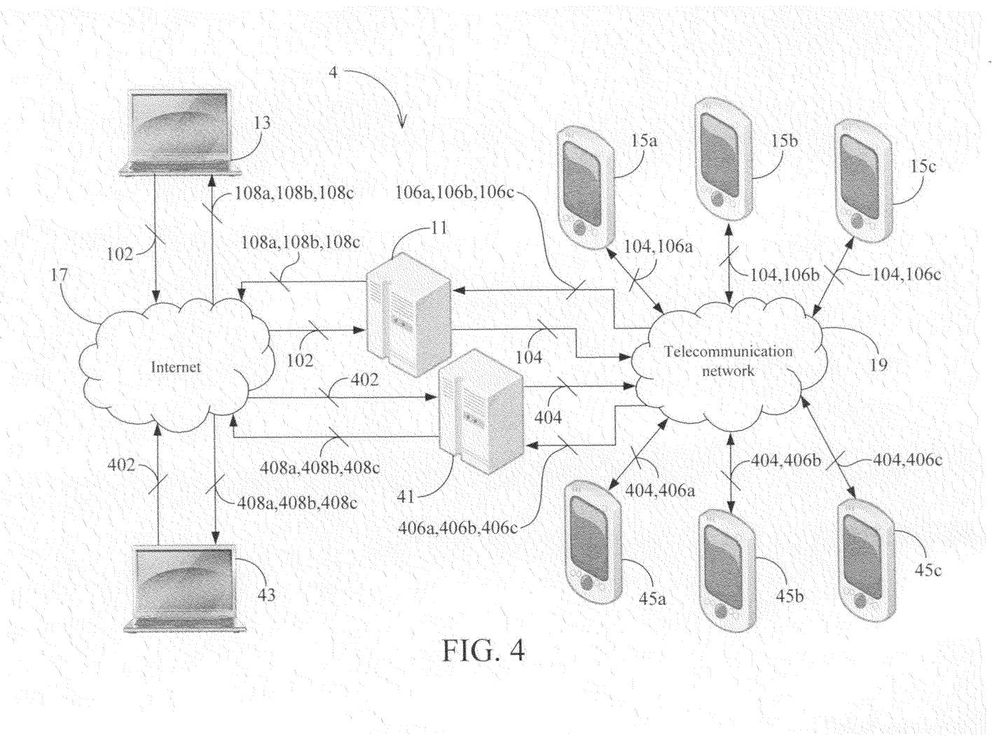

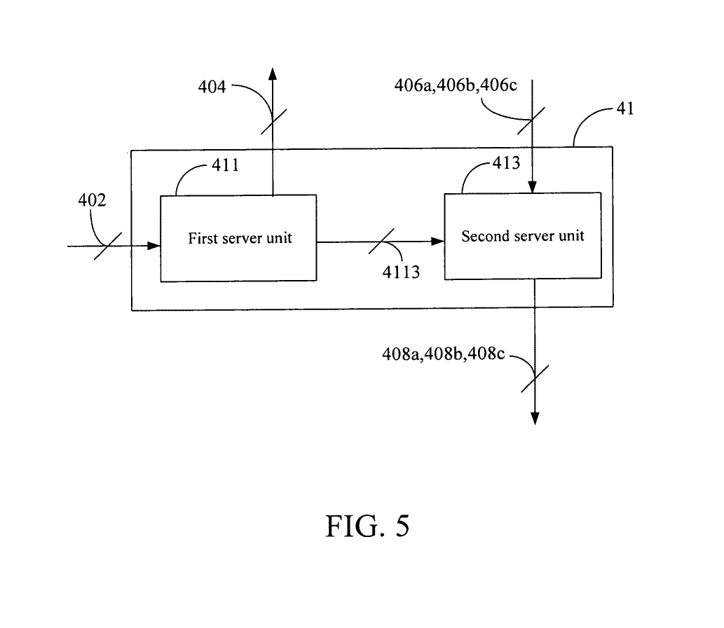

A third embodiment of the present invention is shown in FIG. 4, which is another SMS transceiving system 4. It should be particularly noted that, in the third embodiment, the SMS transceiving system 4 further comprises another SMS transceiving server device 41, another first user device 43 and a plurality of second user devices 45a, 45b, 45c. As shown in FIG. 5, identical to the SMS transceiving server device 11, the SMS transceiving server device 41 also comprises a first server unit 411 and a second server unit 413. The first server unit 411 has another source information (e.g., another phone number information 4113 configured by a telecommunication company) and is electrically connected with the Internet 17 and the telecommunication network 19. The second server unit 413 is electrically connected with the Internet 17 and the telecommunication network 19. The first server unit 411 and the second server unit 413 are also electrically connected with each other. Moreover, the first user device 43 and the second user devices 45a, 45b, 45c described in the third embodiment are also the same as the first user device 13 and the second user devices 15a, 15b, 15c described in the first embodiment respectively.

In this embodiment, when another enterprise or manufacturer desires to have an insurance questionnaire survey, it may transmit another first user message (e.g., an insurance questionnaire survey message 402) from the first user device 43 to the SMS transceiving server device 11 via the Internet 17. Then, the first server unit 411 of the SMS transceiving server device 41 receives the insurance questionnaire survey message 402, assigns the phone number information 4113 to the insurance questionnaire survey message 402, and then transmits a third SMS 404 with the phone number information 4113 and the insurance questionnaire survey message 402 to the second user devices 45a, 45b, 45c respectively via the telecommunication network 19.

Further speaking, the first server unit 411 of the SMS transceiving server device 41 can receive the insurance questionnaire survey message 402 from the first user device 43 through an E-mail or a website via the Internet 17. Subsequently, according to the phone number information 4113 configured by the telecommunication company, the first server unit 411 transmits the third SMS 404 to the second user devices 45a, 45b, 45c via the telecommunication network 19. Thus, the third SMS 404 will have the phone number information 4113 configured by the first server unit 411 of the SMS transceiving server device 41.

After different users have received the third SMS 404 via the second user devices 45a, 45b, 45c respectively, they can decide whether to respond to the insurance questionnaire survey message 402 transmitted by the enterprise or manufacturer. For example, when the users desire to reply second user messages (e.g., insurance response messages 408a, 408b, 408c replied in response to the insurance questionnaire survey message 402), they will transmit fourth SMSs 406a, 406b, 406c with the phone number information 4113 and the insurance response messages 408a, 408b, 408c to the SMS transceiving server device 41 through the second user devices 45a, 45b, 45c respectively. Upon receiving the fourth SMSs 406a, 406b, 406c from the second user devices 45a, 45b, 45c via the telecommunication network 19, the second server unit 413 of the SMS transceiving server device 41 transmits the insurance response messages 408a, 408b, 408c of the fourth SMSs 406a, 406b, 406c to the first user device 43 respectively according to the phone number information 4113 incorporated in the fourth SMSs 406a, 406b, 406c and the phone number information 4113 of the first server unit 411. Specifically, the second server unit 413 of the SMS transceiving server device 41 transmits the insurance response messages 408a, 408b, 408c to the first user device 43 through an E-mail or a website via the Internet 17.

It should be particularly noted that, the aforesaid insurance response messages 408a, 408b, 408c of the fourth SMSs 406a, 406b, 406c may be temporarily stored in the second server unit 413 of the SMS transceiving server device 41 so that the enterprise or manufacturer can read the insurance response messages 408a, 408b, 408c through a website via the first user device 43 or receive the insurance response messages 408a, 408b, 408c transmitted by the second server unit 413 of the SMS transceiving server device 41 through an E-mail by use of an E-mail address.

To be brief, in the third embodiment, the first user device 13 and the first user device 43 are notebook computers and/or personal computers (PCs) of two enterprises or manufacturers respectively. Accordingly, the two enterprises or manufacturers can connect to the SMS transceiving server device 11 and the SMS transceiving server device 41 through the first user device 13 and the first user device 43 respectively, and transmit the first SMS 104 and the third SMS 404 from the SMS transceiving server device 11 and the SMS transceiving server device 41 to the second user devices 15a, 15b, 15c, 45a, 45b, 45c respectively via the telecommunication network 19.

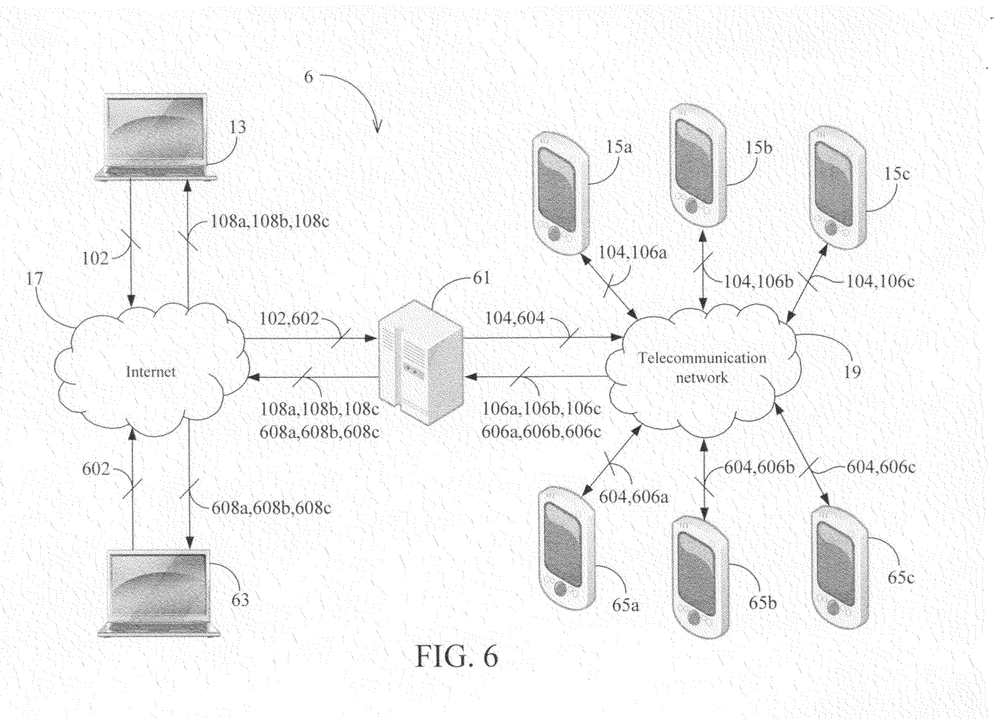

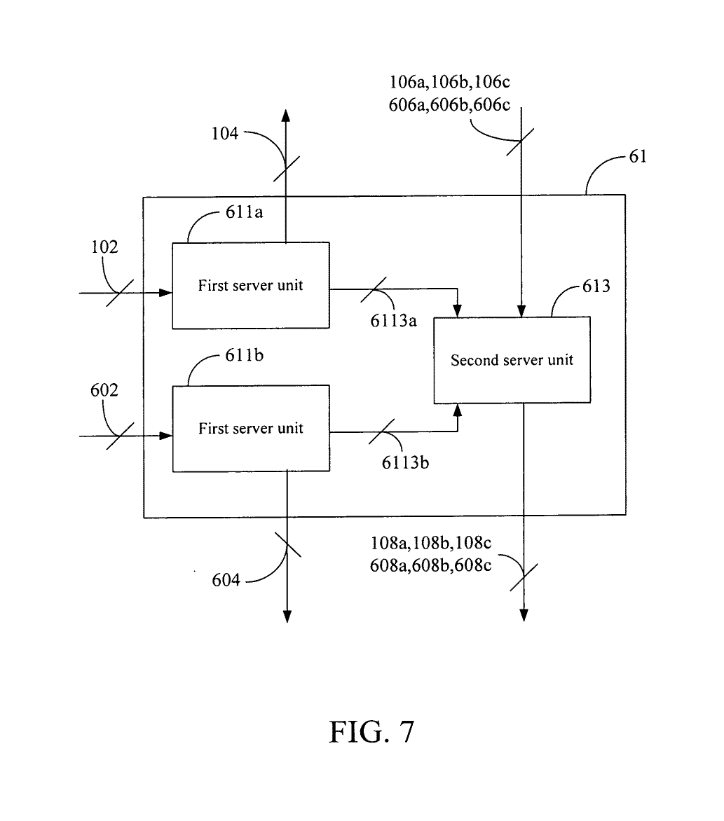

A fourth embodiment of the present invention is shown in FIG. 6, which is another SMS transceiving system 6. It should be particularly noted that, in the fourth embodiment, the SMS transceiving system 6 comprises an SMS transceiving server device 61, another first user device 63 and a plurality of second user devices 65a, 65b, 65c. Meanwhile, as shown in FIG. 7, also different from the SMS transceiving server device 11 of the first embodiment, the SMS transceiving server device 61 of the SMS transceiving system 6 comprises two first server units 611a, 611b and a second server unit 613. The first server units 611a, 611b have respective source information (e.g., phone number information 6113a and phone number information 6113b configured by a telecommunication company) and are both electrically connected with the Internet 17 and the telecommunication network 19. The second server unit 613 is electrically connected with the Internet 17 and the telecommunication network 19. The first server units 611a, 611b are electrically connected with the second server unit 613 respectively. Additionally, the first user device 63 and the second user devices 65a, 65b, 65c described in the fourth embodiment are the same as the first user device 13 and the second user devices 15a, 15b, 15c described in the first embodiment respectively.

In this embodiment, when two enterprises or manufacturers desire to have a product questionnaire survey and a loan questionnaire survey respectively, they may transmit, via the Internet 17, first user messages (e.g., a product questionnaire survey message 102 and a loan questionnaire survey message 602) to the SMS transceiving server device 61 through the first user device 13 and the first user device 43 respectively. Then, the first server unit 611a of the SMS transceiving server device 61 receives the product questionnaire survey message 102, assigns the phone number information 6113a to the product questionnaire survey message 102, and then transmits a first SMS 104 with the phone number information 6113a and the product questionnaire survey message 102 to the second user devices 15a, 15b, 15c respectively via the telecommunication network 19.

Similarly, the first server unit 611b of the SMS transceiving server device 61 receives the loan questionnaire survey message 602, assigns the phone number information 6113b to the loan questionnaire survey message 602, and then transmits a fifth SMS 604 with the phone number information 6113b and the loan questionnaire survey message 602 to the second user devices 65a, 65b, 65c respectively via the telecommunication network 19.

Further speaking, the first server units 611a, 611b of the SMS transceiving server device 61 can receive the product questionnaire survey message 102 and the loan questionnaire survey message 602 from the first user devices 13, 63 through an E-mail or a website via the Internet 17. Subsequently, according to the phone number information 6113a configured by the telecommunication company, the first server unit 611a transmits the first SMS 104 to the second user devices 15a, 15b, 15c via the telecommunication network 19; and meanwhile, according to the phone number information 6113b configured by a telecommunication company, the first server unit 611b transmits the fifth SMS 604 to the second user devices 65a, 65b, 65c via the telecommunication network 19. Thus, the first SMS 104 will have the phone number information 6113a configured by the first server unit 611a of the SMS transceiving server device 61; and the fifth SMS 604 will have the phone number information 6113b configured by the first server unit 611b of the SMS transceiving server device 61.

After different users have received the first SMS 104 through the second user devices 15a, 15b, 15c respectively, they can decide whether to respond to the product questionnaire survey message 102 transmitted by the enterprise or manufacturer. For example, when the users desire to reply second user messages (e.g., product response messages 108a, 108b, 108c replied in response to the product questionnaire survey message 102), they will transmit second SMSs 106a, 106b, 106c with the phone number information 1113 and the product response messages 108a, 108b, 108c to the SMS transceiving server device 61 through the second user devices 15a, 15b, 15c respectively.

Similarly, after different users have received the fifth SMS 604 through the second user devices 65a, 65b, 65c respectively, they can decide whether to respond to the loan questionnaire survey message 602 transmitted by the enterprise or manufacturer. For example, when the users desire to reply second user messages (e.g., loan response messages 608a, 608b, 608c replied in response to the loan questionnaire survey message 602), they will transmit sixth SMSs 606a, 606b, 606c with the phone number information 6113b and the loan response messages 608a, 608b, 608c to the SMS transceiving server device 61 through the second user devices 65a, 65b, 65c respectively.

Upon receiving the second SMSs 106a, 106b, 106c from the second user devices 15a, 15b, 15c via the telecommunication network 19, the second server unit 613 of the SMS transceiving server device 61 transmits the product response messages 108a, 108b, 108c of the second SMSs 106a, 106b, 106c to the first user device 13 respectively according to the phone number information 6113a incorporated in the second SMSs 106a, 106b, 106c and the phone number information 6113a of the first server unit 611a. Specifically, the second server unit 613 of the SMS transceiving server device 61 transmits the product response messages 108a, 108b, 108c to the first user device 13 through an E-mail or a website via the Internet 17.

Meanwhile, upon receiving the sixth SMSs 606a, 606b, 606c from the second user devices 65a, 65b, 65c via the telecommunication network 19, the second server unit 613 of the SMS transceiving server device 61 transmits the loan response messages 608a, 608b, 608c of the sixth SMSs 606a, 606b, 606c to the first user device 63 respectively according to the phone number information 6113b incorporated in the sixth SMSs 606a, 606b, 606c and the phone number information 6113b of the first server unit 611b. Specifically, the second server unit 613 of the SMS transceiving server device 61 transmits the loan response messages 608a, 608b, 608c to the first user device 63 through an E-mail or a website via the Internet 17.

To be brief, in the fourth embodiment, the first user device 13 and the first user device 63 are notebook computers and/or PCs of two enterprises or manufacturers respectively. Accordingly, the two enterprises or manufacturers can connect to the SMS transceiving server device 61 through the first user device 13 and the first user device 63 respectively, and transmit the first SMS 104 and the fifth SMS 604 from the first server unit 611a and the first server unit 611b to the second user devices 15a, 15b, 15c, 65a, 65b, 65c respectively via the telecommunication network 19.

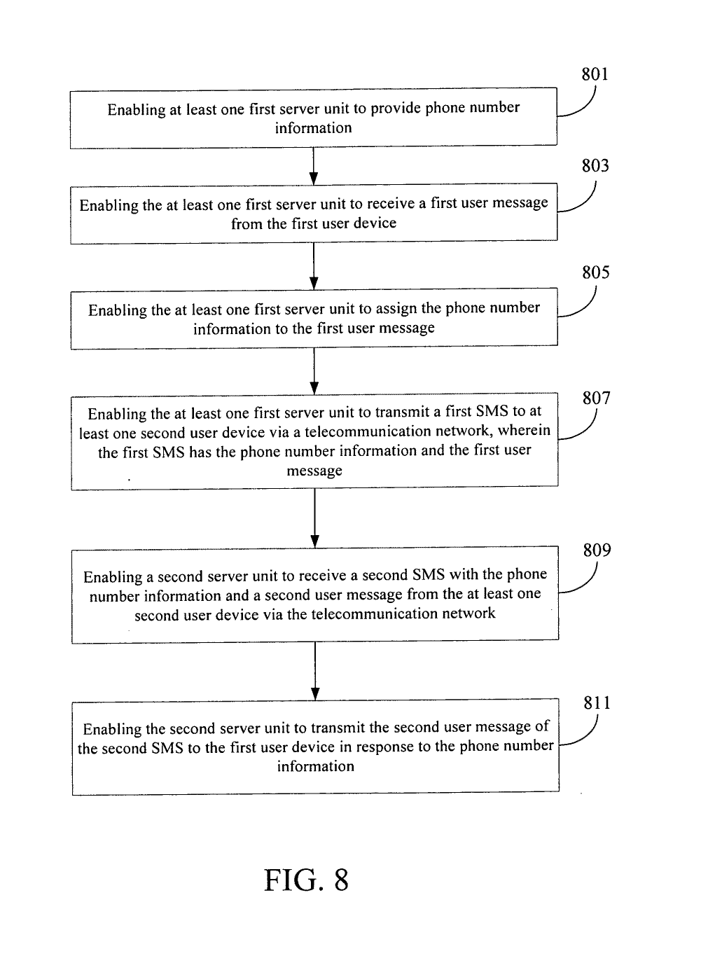

A fifth embodiment of the present invention is shown in FIG. 8, which is an SMS transceiving method adapted for use in an SMS transceiving server device. The SMS transceiving server device may be one of the SMS transceiving server devices 11, 41, 61 described in the first embodiment, the second embodiment, the third embodiment and the fourth embodiment. The SMS transceiving method is adapted for transmitting a plurality of user messages between a plurality of user devices, including a first user device and at least one second user device.

In particular, the SMS transceiving method described in the fifth embodiment may be implemented by a computer program storage product. When the computer program storage product is loaded into the SMS transceiving server device via a computer and a plurality of codes contained therein is executed, the SMS transceiving method described in the fifth embodiment can be accomplished. This computer program storage product may be stored in a tangible machine-readable medium, such as a read only memory (ROM), a flash memory, a floppy disk, a hard disk, a compact disk (CD), a mobile disk, a magnetic tape, a database accessible to networks, or any other storage media with the same functionality and well known to those skilled in the art.

Firstly, step 801 is executed to enable at least one first server unit to provide source information, i.e., to provide phone number information configured by a telecommunication company. Next, step 803 is executed to enable the at least one first server unit to receive a first user message from the first user device; for example, step 803 is to enable the at least one first server unit to receive the first user message from the first user device through one of an E-mail and a website via the Internet, or to enable the at least one first server unit to receive the first user message from the first user device through an SMS via the telecommunication network.

Then, step 805 is executed to enable the at least one first server unit to assign the phone number information to the first user message. Subsequently, step 807 is executed to enable the at least one first server unit to transmit a first SMS to the second user device via the telecommunication network. Here, the first SMS has the phone number information and the first user message.

Next, step 809 is executed to enable a second server unit to receive a second SMS with the phone number information and a second user message from the second user device via the telecommunication network. Afterwards, step 811 is executed to enable the second server unit to transmit the second user message of the second SMS to the first user device in response to the phone number information. Here, the second SMS is replied by the second user device in response to the first SMS. In particular, the second server unit will store the second SMS and further, in response to the phone number information, transmit the second user message of the second SMS to the first user device through an E-mail or a website via the Internet or transmit the second user message of the second SMS to the first user device through an SMS via the telecommunication network.

In addition to the aforesaid steps, the SMS transceiving method of the present invention can also execute all the operations and functions set forth in the first, the second, the third and the fourth embodiments. How the SMS transceiving method of the present invention executes these operations and functions will be readily appreciated by those of ordinary skill in the art based on the explanation of the first, the second, the third and the fourth embodiments, and thus will not be further described herein.

According to the above descriptions, the SMS transceiving server device, the SMS transceiving method and the computer program storage product thereof according to the present invention can transmit a plurality of user messages between a plurality of user devices. When a plurality of enterprises or manufacturers transmit SMSs to cell phones or PDAs of their customers through the SMS transceiving server device of the present invention, the customers of the enterprises or manufacturers can reply SMSs to the SMS transceiving server device according to contents of the SMSs received. Then, the SMS transceiving server device can recognize the enterprises or manufacturers to which the replying SMSs correspond according to the phone number information and, further, transmit the contents of the replying SMSs to the corresponding enterprises or manufacturers through an E-mail, a website or an SMS. Thus, the SMS transceiving server device, the SMS transceiving method and the computer program storage product thereof according to the present invention will be able to transmit SMSs of a plurality of enterprises or manufacturers to different customers, receive replying SMSs from the customers and recognize to which enterprises or manufacturers the replying SMSs correspond, thereby avoiding inconveniences in use.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A short message service (SMS) transceiving server device for transmitting a plurality of user messages between a plurality of user devices, the user devices comprising a first user device and at least one second user device, the SMS transceiving server device comprising:
at least one first server unit, being electrically connected to a telecommunication network and having a source information, being configured to receive a first user message from the first user device, to assign the source information to the first user message, and to transmit a first SMS with the source information and the first user message to the at least one second user device via the telecommunication network, the first SMS having the source information and the first user information; and
a second server unit, electrically connected to the telecommunication network, being configured to receive at least one second SMS with the source information and a second user message from the at least one second user device via the telecommunication network, and to transmit the second user message of the at least one second SMS to the first user device in response to the source information;
wherein the at least one second user device replies the at least one second SMS in response to the first SMS.

2. The SMS transceiving server device as claimed in claim 1, wherein the at least one first server unit is further electrically connected to a Internet, and is further configured to receive the first user message from the first user device through one of an E-mail and a website via the Internet.

3. The SMS transceiving server device as claimed in claim 2, wherein the at least one first server unit is electrically connected to the telecommunication network and the Internet respectively via one of a wireless connection and a wired connection.

4. The SMS transceiving server device as claimed in claim 3, wherein the wireless connection is one of a Third Generation (3G) mobile network transmission mode, a General Packet Radio Service (GPRS) transmission mode, a Wireless Local Area Network (WLAN) transmission mode and a Worldwide Interoperability for Microwave Access (WiMAX) transmission mode.

5. The SMS transceiving server device as claimed in claim 1, wherein the at least one first server unit receives the first user message from the first user device through an SMS transmission via the telecommunication network.

6. The SMS transceiving server device as claimed in claim 1, wherein the second server unit is further electrically connected to a Internet, and is further configured to store the at least one second SMS so as to transmit the second user message of the at least one second SMS to the first user device through an E-mail or a website in response to the source information via the Internet.

7. The SMS transceiving server device as claimed in claim 6, wherein the second server unit is electrically connected to the telecommunication and the Internet respectively via one of a wireless connection and a wired connection.

8. The SMS transceiving server device as claimed in claim 7, wherein the wireless connection is one of a 3G mobile network transmission mode, a GPRS transmission mode, a WLAN transmission mode and a WiMAX transmission mode.

9. The SMS transceiving server device as claimed in claim 1, wherein the second server unit is further configured to store the at least one second SMS so as to transmit the second user message of the at least one second SMS to the first user device through an SMS transmission in response to the source information via the telecommunication network.

10. The SMS transceiving server device as claimed in claim 1, wherein the first user device is one of a cell phone, a personal digital assistant (PDA) and a personal computer (PC).

11. The SMS transceiving server device as claimed in claim 1, wherein the at least one second user device is one of a cell phone, a PDA and a PC.

12. The SMS transceiving server device as claimed in claim 1, wherein the at least one first server unit comprises a plurality of first server units, and each of the first server units comprises a source information.

13. An SMS transceiving method for transmitting a plurality of user messages between a plurality of user devices, the user devices comprising a first user device and at least one second user device, the SMS transceiving method comprising the following steps of:
(A) enabling at least one first server unit to provide a source information;
(B) enabling the at least one first server unit to receive a first user message from the first user device;
(C) enabling the at least one first server unit to assign the source information to the first user message;
(D) enabling the at least one first server unit to transmit a first SMS with the source information and the first user message to the at least one second user device via a telecommunication network, the first SMS having the source information and the first user information;
(E) enabling a second server unit to receive at least one second SMS with the source information and a second user message from the at least one second user device via the telecommunication network; and
(F) enabling the second server unit to transmit the second user message of the at least one second SMS to the first user device in response to the source information;
wherein the at least one second user device replies the at least one second SMS in response to the first SMS.

14. The SMS transceiving method as claimed in claim 13, wherein the step (B) further comprises the following step of:
(B1) enabling the at least one first server unit to receive the first user message from the first user device through one of an E-mail and a website via a Internet.

15. The SMS transceiving method as claimed in claim 13, wherein the step (B) further comprises the following step of:
(B2) enabling the at least one first server unit to receive the first user message from the first user device through an SMS transmission via the telecommunication network.

16. The SMS transceiving method as claimed in claim 13, wherein the step (F) further comprises the following steps of:
(F1) enabling the second server unit to store the at least one second SMS; and
(F2) enabling the second server unit to transmit the second user message of the at least one second SMS to the first user device through one of an E-mail and a website in response to the source information via an Internet.

17. The SMS transceiving method as claimed in claim 13, wherein the step (F) further comprises the following steps of:
(F3) enabling the second server unit to store the at least one second SMS; and
(F4) enabling the second server unit to transmit the second user message of the at least one second SMS to the first user device through an SMS transmission in response to the source information via the telecommunication network.

18. The SMS transceiving method as claimed in claim 13, wherein the at least one first server unit comprises a plurality of first server units, the step (A) further comprises the following step of:
(A1) enabling each of the first server units to provide a source information.

19. A computer program storage product, comprising a computer readable medium storing a program for an SMS transceiving server device to execute an SMS transceiving method for transmitting a plurality of user messages between a plurality of user devices, the plurality of user devices comprising a first user device and at least one second user device, the program comprising:
a code A for enabling the at least one first server unit to provide a source information;
a code B for enabling the at least one first server unit to receive a first user message from the first user device;
a code C for enabling the at least one first server unit to assign the source information to the first user message;
a code D for enabling the at least one first server unit to transmit a first SMS with the source information and the first user message to the at least one second user device via a telecommunication network, the first SMS having the source information and the first user information;
a code E for enabling a second server unit to receive at least one second SMS with the source information and a second user message from the at least one second user device via the telecommunication network; and
a code F for enabling the second server unit to transmit the second user message of the at least one second SMS to the first user device in response to the source information;
wherein the at least one second user device replies the at least one second SMS in response to the first SMS.

20. The computer program storage product as claimed in claim 19, wherein the code B further comprises:
a code B1 for enabling the at least one first server unit to receive the first user message from the first user device through one of an E-mail and a website via a Internet.

21. The computer program storage product as claimed in claim 19, wherein the code B further comprises:
a code B2 for enabling the at least one first server unit to receive the first user message from the first user device through an SMS transmission via the telecommunication network.

22. The computer program storage product as claimed in claim 19, wherein the code F further comprises:
a code F1 for enabling the second server unit to store the at least one second SMS; and
a code F2 for enabling the second server unit to transmit the second user message of the at least one second SMS to the first user device through one of an E-mail and a website in response to the source information via a Internet.

23. The computer program storage product as claimed in claim 19, wherein the code F further comprises:
a code F3 for enabling the second server unit to store the at least one second SMS; and
a code F4 for enabling the second server unit to transmit the second user message of the at least one second SMS to the first user device through an SMS transmission in response to the source information via the telecommunication network.

24. The computer program storage product as claimed in claim 19, wherein the at least one first server unit comprises a plurality of first server units, and the code A further comprises:
a code A1 for enabling each of the first server units to provide a source information.
